(19) United States
(12) Patent Application Publication
(10) Pub. No.: US 2006/0053985 A1
(43) Pub. Date: Mar. 16, 2006

(54) Floatable handle for hand tools

(76) Inventor: Chien-Te Chen, Taichung (TW)

Correspondence Address: Mr. Phillip Liu, 6980, Whiteoak Dr., Richmond, BC, V7E 4Z9, CA

(21) Appl. No.: 10/940,674

(22) Filed: Sep. 15, 2004

(51) Int. Cl. B25G 1/01

(52) U.S. Cl. 81/489

(57) ABSTRACT

A handle of a hand tool includes an enclosed chamber defined therein and a shank is connected to an end of the handle. The enclosed chamber allows the handle to be floatable in water. A fluorescent layer is coated on an outer periphery of the handle such that the handle can be seen in dark.

### FIELD OF THE INVENTION

The present invention relates to a floatable handle having a enclosed chamber defined therein such that the tool with the handle floats in the water.

### BACKGROUND OF THE INVENTION

A conventional hand tool such as a screw driver generally includes a handle and a shank is connected to an end of the handle. The handle is a solid handle which is heavy can cannot float in water. When the hand tools with solid handles are used in work sites where located above waters, such as bridges or ships maintenance, once the hand tools drop into water, they cannot be retrieved. Although some handles do have a recess defined therein for receiving small bits therein, the recess is not well sealed for convenience of accessing the bits received therein. This type of handles cannot float either.

The present invention intends to provide a hand tool that includes a handle with an enclosed chamber such that the handle floats in the water.

### SUMMARY OF THE INVENTION

The present invention relates to a hand tool that comprises a handle having an enclosed chamber defined therein and a shank is connected to an end of the handle. The handle floats in water because of the chamber so that the hand tool can be easily retrieved if the hand tool drops in the water.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hand tool with a floatable handle of the present invention;

FIG. 2 is a cross sectional view to show the hand tool with a floatable handle of the present invention;

FIG. 3 shows another embodiment of the hand tool with a floatable handle of the present invention;

FIG. 4 shows that the handle floats in the water;

FIG. 5 is a cross sectional view to show yet another embodiment of the hand tool with a floatable handle of the present invention, and

FIG. 6 shows that a fluorescent layer is coated on an outer periphery of the handle.

### DETAILED DESCRIPTION OF THE PREFERRED EMBODIMENT

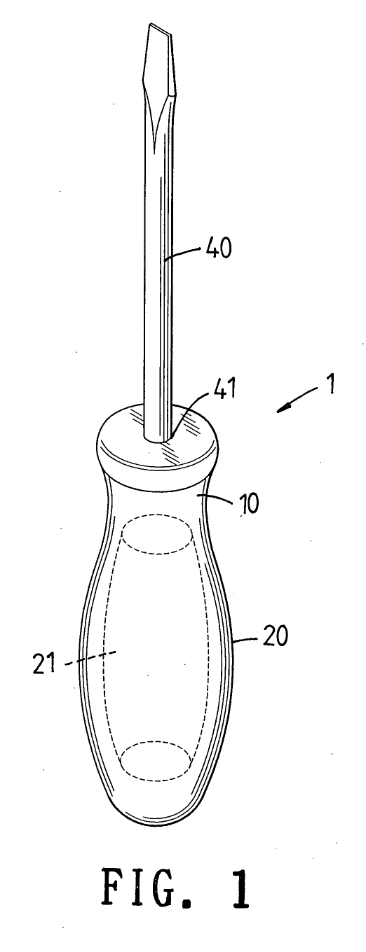

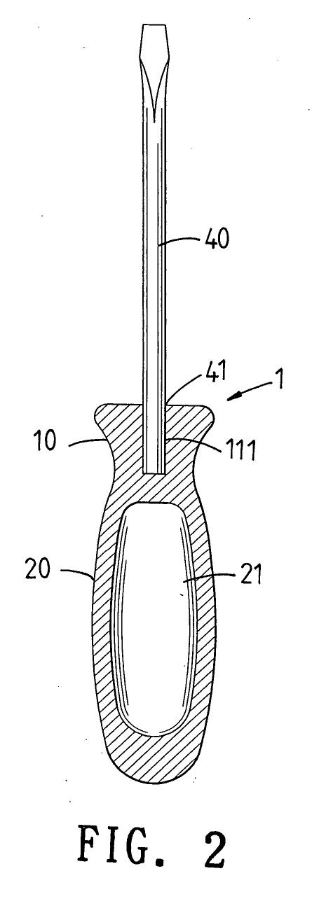

Referring to FIGS. 1 and 2, the hand tool 1 of the present invention comprises a handle 20 having an enclosed chamber 21 defined therein and a recess 111 is defined in a first end of the handle 10. An end 41 of a shank 40 is fixedly inserted in the recess 111. It is noted that the handle 20 is solid except for the chamber 21.

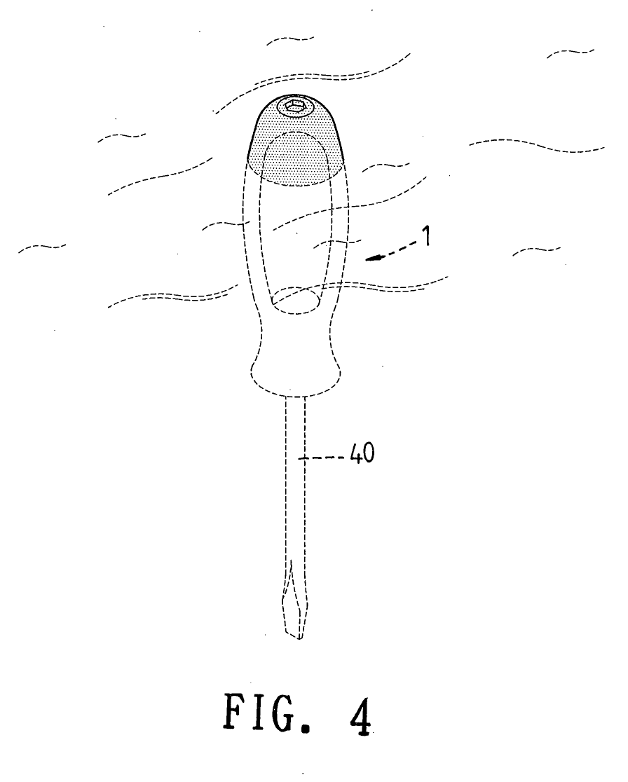

As shown in FIG. 4, when the hand tool 1 drops into water, because of the chamber 21 in the handle 20, the handle 20 floats.

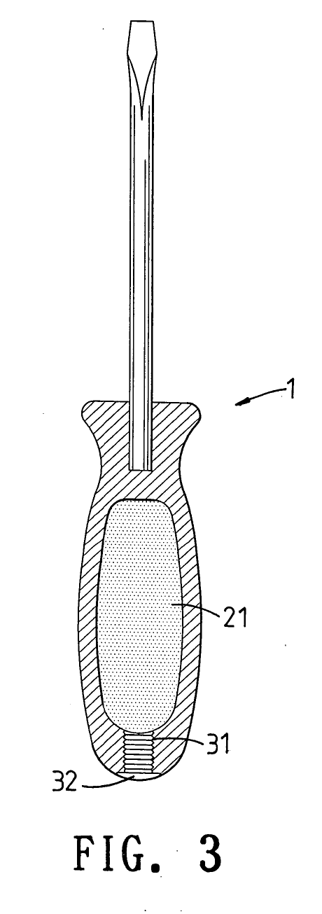

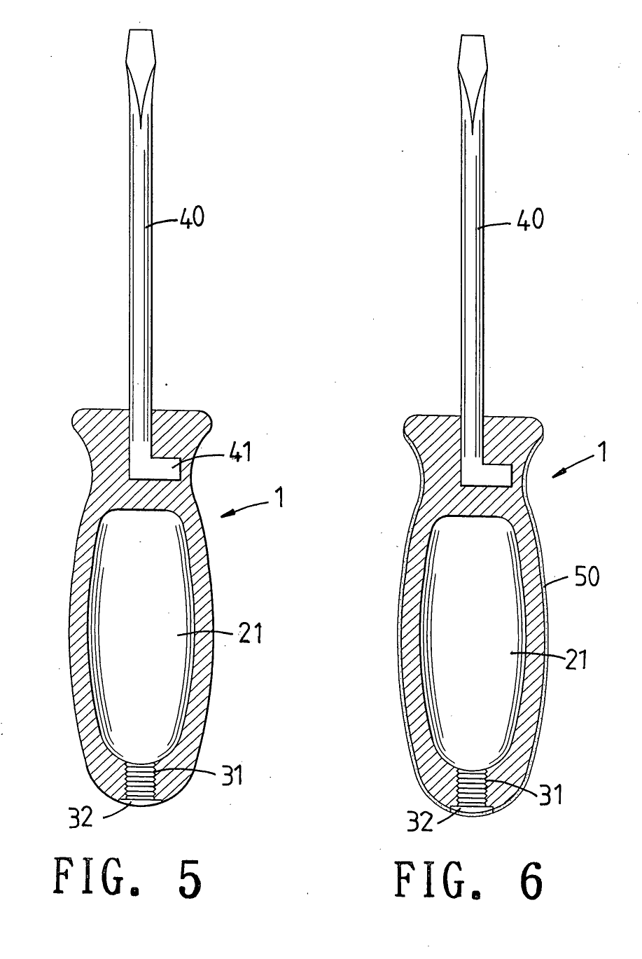

As shown in FIG. 3, the recess is an L-shaped recess and the end 41 of the shank 40 is an L-shaped end such that the shank 40 is firmly combined with the handle 20. FIG. 5 shows that a hole 31 is defined in a second end of the handle 10 and in communication with the chamber 21, and a bolt 32 seals the hole 31. By unscrewing the bolt 32, the chamber 21 can be filled with sands to increase its weight and performs like the conventional hand tools if the hand tool 1 is not used above the water.

FIG. 5 shows that a fluorescent layer 50 is coated on an outer periphery of the handle 10 so that the handle 20 can be seen in a dark area.

While we have shown and described the embodiment in accordance with the present invention, it should be clear to those skilled in the art that further embodiments may be made without departing from the scope of the present invention.

What is claimed is:

1. A hand tool comprising:
a handle having an enclosed chamber defined therein, and
a shank connected to a first end of the handle.

2. The hand tool as claimed in claim 1, wherein the handle includes a recess defined in the end thereof and an end of the shank is fixedly inserted in the recess.

3. The hand tool as claimed in claim 2, wherein the recess is an L-shaped recess and the end of the shank is an L-shaped end.

4. The hand tool as claimed in claim 1 further comprising a hole defined in a second end of the handle and being in communication with the chamber, a bolt seals the hole.

5. The hand tool as claimed in claim 1, wherein a fluorescent layer is coated on an outer periphery of the handle.
